(19) United States
(12) Patent Application Publication
(10) Pub. No.: US 2007/0295542 A1
(43) Pub. Date: Dec. 27, 2007

(54) Electric Steering Apparatus for Floor Transport Vehicle

(76) Inventor: Josef Raue, Dulmen (DE)

Correspondence Address: GOODMAN, ALLEN & FILETTI PLLC, 4501 HIGHWOODS PARKWAY, SUITE 210, GLEN ALLEN, VA, 23060, US

(21) Appl. No.: 11/767,462

(22) Filed: Jun. 22, 2007

(30) Foreign Application Priority Data
Jun. 23, 2006 (DE) DE102006029283.9

(51) Int. Cl. B60K 17/30

(52) U.S. Cl. 180/6.38

(57) ABSTRACT

An electric steering apparatus, particularly suited for floor transport vehicles, comprises a housing, a steering motor operably connected to a reduction gear stage wherein the reduction gear stage is operably connected to rotating bearing assembly coupled in a torque-proof manner to a steerable running wheel. Precise steering motion with continuous control capability is provided by translating the drive motor output through the reduction gear stage to the rotating bearing assembly. Finer and more precise steering motion than that afforded by conventional hydraulically actuated steering units is thus provided. Steering motion is also advantageously continuously controllable through rotation angle sensors integral to the rotating bearing assembly. A three stage planetary reduction gear systems coupled to a rotating bearing assembly advantageously transfers large torques, so that large loads may be accommodated while maintaining fine steering control.

### RELATED APPLICATIONS

This application claims priority from, and incorporates by reference, German patent application serial No. DE 10 2006 029 283.9, filed Jun. 23, 2006.

### BACKGROUND

1. Field of the Invention

The invention relates to a steering apparatus, in particular a steering apparatus for floor transport vehicles, comprising a housing with steering gear, coupled to at least one steerable running wheel.

2. Introduction

Steering units similar to this invention are mostly required for floor transport vehicles, i.e. forklifts and other material handling equipment, and typically comprise a hydraulically actuated steering gear assembly. In such cases, a gear rack which is operably connected to a sprocket gear and enclosed in a steering gear housing is guided in a longitudinally slideable manner within the steering housing through hydraulic actuation. The sprocket gear itself is directly connected to a wheel carrier through a shaft, or it is connected therewith in a torque-proof manner, that is, so that torque applied to the sprocket gear rotates the sprocket gear and the wheel carrier in an identical fashion and therefore the two components rotate as one. Through one-sided pressure loading of the hydraulic steering gear it is possible to slide the gear rack within the housing, so that this longitudinal motion can be transposed into a rotation of the sprocket gear, thus rotating the running wheel.

The German Patent Document DE 24 06 610 C2 discloses such a hydraulic steering gear, wherein the gear rack is supported in a cylinder bushing in a sealed manner, and can be loaded on one side with a hydraulic medium. For this purpose, a hydraulic cylinder is used and is connected to the steering gear box via connection lines. One significant disadvantage of such hydraulically actuated steering gears of this type is that they do not afford the fine steering adjustment necessary to allow users to determine with precision the position of the steering gear through electronic means.

Another steering gear of the hydraulically actuated variety is disclosed in U.S. Pat. No. 4,986,387. This apparatus comprises a steering rack which is guided or loaded by hydraulic cylinder means from one side. Like the apparatus disclosed in the German reference, this apparatus comprises a steering rack with sprocket gear which is directly connected to the steerable running wheel and, therefore, it suffers the same drawbacks.

Both of these steering devices provide the possibility that maximum steering deflection can be determined through the utilization of end switches. However, it is also desirable to detect small steering deflections during steering operation, particularly in order to perform fully automatic steering.

3. Objects of the Invention

For these reasons, the objects of the present invention are to provide an electric steering unit which is not hydraulically actuated and which provides fine and precise steering motion, and additionally permits precise determination of the position of the running wheels so that such data may be transmitted to available automatic steering devices.

### BRIEF SUMMARY OF THE INVENTION

According to the present invention, these objects are achieved by a steering apparatus provided in which a steering motor is operably coupled to at least one reduction gear stage and the reduction gear stage is operably connected through a rotating bearing assembly to a steerable running wheel.

Instead of using a hydraulically actuated steering unit, the invention proposes a fundamentally new approach, that is, the use of a reduction gear stage, coupled to a steering motor. The steering motor itself can advantageously be an electric motor. However, it is also conceivable that other motor variants can be used. The conventional rack and pinion steering system is completely done away with and instead rotational gear components are used to directly cause the rotating motion of the steerable running wheel. This provides the advantage that through the steering motor and the reduction stage, a much more exact steering position can be reached. Additionally the steering deflection can be detected through simple and economical sensors, and thus electronic feedback can be provided. Accordingly, automated control of the floor transport vehicle is facilitated since it is possible to control the steering apparatus in response to the steering angle data provided by the sensors. Steering correction can, therefore, be performed continuously through a control unit or according to a steering angle predetermined by the driver and directly translated into a new deflection angle of the running wheel.

The present invention also provides the advantage that a hydraulic unit can be completely dispensed with. Since many floor transport vehicles have an available operating voltage provided for the propulsion system of the vehicle, the same voltage can also be used for controlling the steering unit by employing an electric steering motor.

The steering apparatus is advantageously configured so that the reduction gear stage and the steering motor are arranged symmetrically around a common axis. In such a fashion, the unit is advantageously more compact than common prior art hydraulically actuated steering units and the available storage capacity can be used for other elements of the vehicle. Preferably one element of the reduction gear stage is provided by a planetary gear system. Either a single stage or multistage planetary gear system may be employed. The use of the reduction gear stage and particularly a reduction gear stage employing a multistage planetary gear system allows steering motion of a small deflection to be performed with relatively high revolution speeds. Through the use of at least one reduction gear stage a small steering motor with strong dynamic properties can preferably be used.

In the preferred embodiment, an electric steering motor is received by the housing of the reduction gear stage. The upper portion of the reduction gear housing forms a pot shaped shell such that the housing of the steering motor can be attached to the reduction gear stage through a flange in a flush manner. The steering motor and the reduction gear stage thereby form a desired compact unit, which is both maintenance friendly and substantially avoids the deposition of dirt, etc. The components of the reduction gear stage are disposed within a bell shaped housing adjacent the connection with the steering motor. The reduction gear stage is operably connected to the wheel carrier by a rotating bearing assembly. Through the rotating bearing assembly high loads can be received without difficulty, yet simultaneously, a minimal rotating motion of the steering wheel acting through the electric steering motor and reduction gear stage effects adequate steering motion.

The reduction gear stage housing is connected with the outer race of the rotating bearing assembly, preferably through threaded connectors, while the wheel carrier is connected to the inner race of the rotating bearing assembly, also preferably through threaded connectors. Alternatively, the inner race of the rotating bearing assembly and the wheel carrier can be provided integrally. The load to be received, which is transferred to the running wheels through the wheel carriers, is thereby exclusively received by the rotating bearing assembly, which in addition to being connected to the reduction gear stage is also connected to the frame of the vehicle, so that all forces, in particular, the operating loads, are directly transferred through the rotating bearing assembly to the wheel carrier and the running wheels. The outer race and the inner race of the rotating bearing assembly thereby simultaneously form the closure of the housing on the wheel carrier side of the reduction gear stage. In order to receive high loads, it is further provided that the inner race of the rotating bearing assembly is supported relative to the outer race of the rotating bearing assembly through several bearing elements. Further, a gasket is disposed between the rotating bearing assembly outer race, and the wheel carrier, so that gear grease can be deposited within the rotating bearing assembly and cannot exit from the steering housing.

In a particular embodiment of the present invention, it is provided that the rotating bearing assembly inner race also forms the planet carrier of the output planetary reduction gear. In such fashion the number of components can be significantly reduced, and furthermore direct drive of the wheel carrier is accomplished without large tolerances occurring in the steering motion.

The hollow or annulus gears of the planetary gear system are connected torque-proof with the housing and therefore have the additional advantage that they are supported through the outer housing and radial forces which occur are directly transferred into the housing, while the output is generated through the sun gear, or through a planet carrier, directly to the rotating bearing assembly inner race.

The wheel carrier itself is provided for receiving at least one and preferably two running wheels, which are supported via bearing elements of the wheel carrier and wherein the running wheels are provided as non-driven running wheels.

In the preferred embodiment, the steering motor comprises an electric motor and it is disposed symmetrically about the longitudinal axis of the steering unit. The rotating bearing assembly is disposed between the steering motor and the wheel carrier, wherein the rotating bearing assembly inner race is simultaneously provided as planet carrier of the output reduction gear stage. In this fashion, a compact unit is created, which can be manufactured from few parts, and which can bear high loads, while simultaneously affording sensitive steering control.

In an additional preferred embodiment which affords monitoring of the steering angle, a gear disc is disposed on an axis of a planetary gear on the inner race, wherein the gear disc rotates with the inner race planet carrier. The gear disc in turn drives a rotation sensor either directly or indirectly via an additional gear, which senses the position of the rotating bearing assembly inner race through sensor elements which afford digital data encoding. These elements sense the steering angle of the running wheels. Through use of these rotation angle sensors, electronic controls may be coupled to the unit so that automated control can be performed. The rotation angle sensor allows precise control of the running wheels and continuous control, in order to allow operation in a fully automatic operating mode.

The rotation angle sensor is provided with an encoding mechanism, wherein the encoding is typically performed through a disc with holes, or a structured magneto sensitive structure, so that light switches or magnetic semiconductors can be used as sensor elements, e.g. GMR (giant magnetoresistance) sensors. In one preferred embodiment, the rotation angle sensor is connected to the housing through a flange disposed directly laterally beside the steering motor.

A new electric steering apparatus is therefore provided according to the invention, which is particularly suitable for floor transport vehicles and which comprises at least one housing with a steering motor and at least one reduction gear stage. The steering motor can advantageously be an electric steering motor. The steering motor rotating through the reduction gear stage operates the rotating bearing assembly and thereby effects fine rotation of the running wheels. Additionally, the position of the running wheel can be determined continuously through a rotation angle sensor. The rotation angle sensor is coupled with the output reduction gear stage, so that any steering deflection can be directly detected by the rotation angle sensor.

The invention advantageously provides a fine steering motion performed through an electric steering motor and a reduction gear stage, which is preferable to the more generous tolerances of the conventional rack and pinion steering system, and which can furthermore be implemented without the use of a hydraulic unit. This steering unit is preferably used in floor transport vehicles, e.g. forklifts, which are already provided with an onboard voltage through batteries, and which are provided with an electric steering motor, so that an electric steering unit can also be used as a supplement to the electric propulsion system. A further advantage achieved is that immediate control of the steering angle is possible through a rotation angle sensor.

### BRIEF DESCRIPTION OF THE DRAWINGS

The invention is described in detail with reference to the following drawings in which like reference numerals refer to like elements:

FIG. 1 illustrates a steering unit according to the invention in a partial sectional view;

FIG. 2 illustrates a floor transport vehicle with a steering unit according to the invention in a perspective view; and

FIG. 3 illustrates an enlarged cutout sectional view of the gear reduction with rotation angle sensor.

Table of Reference Numerals

| Reference No. | Description |
|---|---|
| 1 | Steering apparatus |
| 2 | Housing |
| 3 | Steering motor |
| 4 | Wheel carrier |
| 5 | Planetary reduction gear system |
| 5.1 | Planetary reduction gear |
| 5.2 | Planetary reduction gear |
| 5.3 | Planetary reduction gear |
| 6 | Planet carrier |
| 7 | Rotating bearing assembly |
| 8 | Rotating bearing assembly outer race |
| 9 | Rotating bearing assembly inner race |
| 10 | Threaded bolt |
| 11 | Support means |
| 12 | Wheel receiver |
| 13 | Mounting bolt |
| 14 | Drive shaft |
| 15 | Bearing elements |
| 17 | Threaded connector |
| 18 | Vehicle frame |
| 19 | Support means |
| 20 | Support means |
| 30 | Bore hole |
| 31 | Planetary gear axle |
| 32 | Planetary reduction gear |
| 33 | Shoulder |
| 34 | Gear disc |
| 35 | Rotation angle sensor |
| 36 | Sprocket gear |
| 37 | Bore hole |
| 100 | Floor transport vehicle |
| 101 | Drive shaft |
| 102 | Steering unit |
| 103 | Superstructure |
| 104 | Driver's seat |
| 105 | Steering wheel |
| 106 | Cabin roof |
| 107 | Fork |
| 108 | Guide |
| 109 | Running wheel |
| 110 | Steering motor |
| 111 | Housing |
| 112 | Steerable wheel |

### DETAILED DESCRIPTION OF THE INVENTION

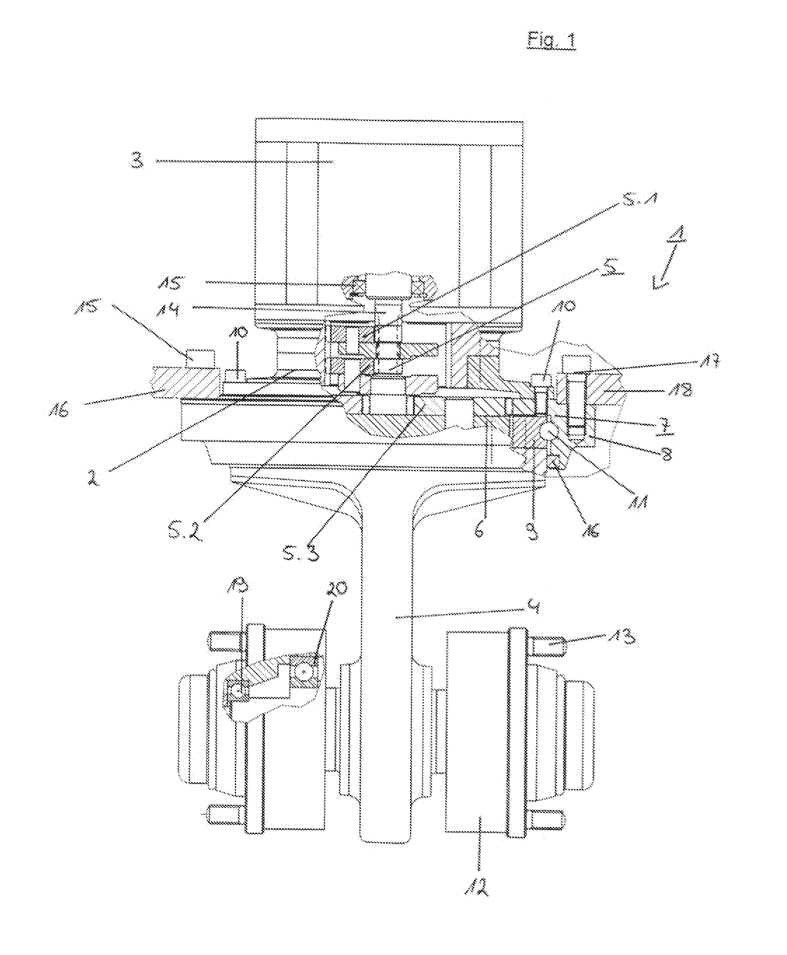

FIG. 1 shows a steering apparatus 1 according to the invention, which can be used for steering of a floor transport vehicle, which is not shown. The steering apparatus 1 is comprised of a housing 2 and a steering motor 3, and it is connected to the wheel carrier 4 through a flange, which is provided for receiving two running wheels, which are not shown. The steering motor 3 is directly connected to the housing 2 via a flange, and connected and mounted to the housing 2 through mounting bolts, which are not shown. The drive shaft 14 of the steering motor 3 is supported through bearing elements 15. The housing 2 has a dish-shaped form on the motor side onto which the steering motor 3 is placed with its housing, so that a seamless attachment is accomplished. Within the housing 2, a three stage planetary reduction gear system 5 is installed in the shown embodiment, which is provided for transferring the rotation of the steering motor 3 into steering motion of the wheel carrier 4. The particular planetary reduction gears 5.1, 5.2, and 5.3 are installed in the housing 2 nested into each other, wherein the respective annulus gears are connected in a torque-proof manner with housing 2. A planet carrier 6 of the third reduction stage is similarly connected in a torque-proof manner with the wheel carrier 4, and is used to output the steering motion. The wheel carrier 4 is connected to the housing 2 through a rotating bearing assembly 7, comprising a rotating bearing assembly outer race 8 and a rotating bearing assembly inner race 9. The rotating bearing assembly outer race 8 is connected to the housing 2 through threaded bolts 10 in a torque-proof manner, and connected with the frame 18 of the vehicle by additional threaded connectors 17, while the rotating bearing assembly inner race 9 is supported through support means 11 and connected in a torque-proof manner on the one hand with the wheel carrier 4, and on the other hand with the planet carrier 6. Between the wheel carrier 4, and the rotating bearing assembly inner race 9, and the rotating bearing assembly outer race 8, a seal ring 16 is provided for sealing the reduction gear stage, so that lubrication means, e.g. gear grease, can be deposition therein and cannot exit from within the reduction gear stage.

The wheel carrier 4 of the preferred embodiment receives two running wheels, which are supported on a shaft stub respectively. Hereby a respective wheel receiver 12 is placed onto one side of the shaft stub, which in turn, is supported via support means 19, 20, relative to the shaft stub, and has mounting bolts 13, onto which the running wheel is placed and bolted tight. Alternatively a wheel carrier can be provided for receiving only a single running wheel.

It is particular to the present invention that instead of a conventional hydraulic steering gear, a steering gear with an electric steering motor and a reduction stage are being used, wherein the high speed rotation of the steering motor is stepped down by a three stage planetary reduction gear system 5, so far that the rotating bearing assembly inner race 9, which is directly connected to the wheel carrier 4, performs a slow rotation, which is used as a steering motion for the running wheels. The performed rotation thereby is precise and provided with small tolerances. It is a distinct advantage that high torques can be transferred hereby. Furthermore the exact position can be determined through respective sensors.

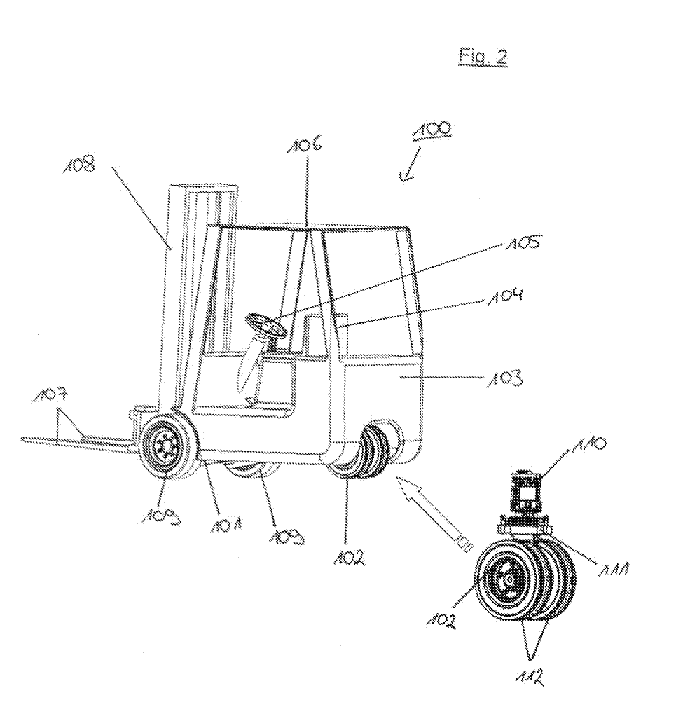

FIG. 2 shows a floor transport vehicle 100 in a respective rear view with a front drive shaft 101 and a rear steering unit 102, which is shown again in a particular view in FIG. 2. The floor transport vehicle 100 has a box shaped superstructure 103 with a driver's seat 104 and a steering wheel 105, which acts directly upon the steering unit 102. An open cabin roof 106 is disposed around the driver's seat 104, which should protect the driver from falling objects. The floor transport vehicle 100 has two forks 107 for lifting loads, which are disposed in a guide 108 so they can be moved upwards. The front axle 101 has two single wheels 109, each of them having a drive motor which is not shown. The rear steering unit 102 comprises a steering motor 110 with a housing 111, a reduction gear stage and a rotating bearing assembly, so that the two steerable wheels 112 can be maneuvered into their respective positions through the steering wheel 105. Details of the steering unit 102 can be derived from FIG. 1.

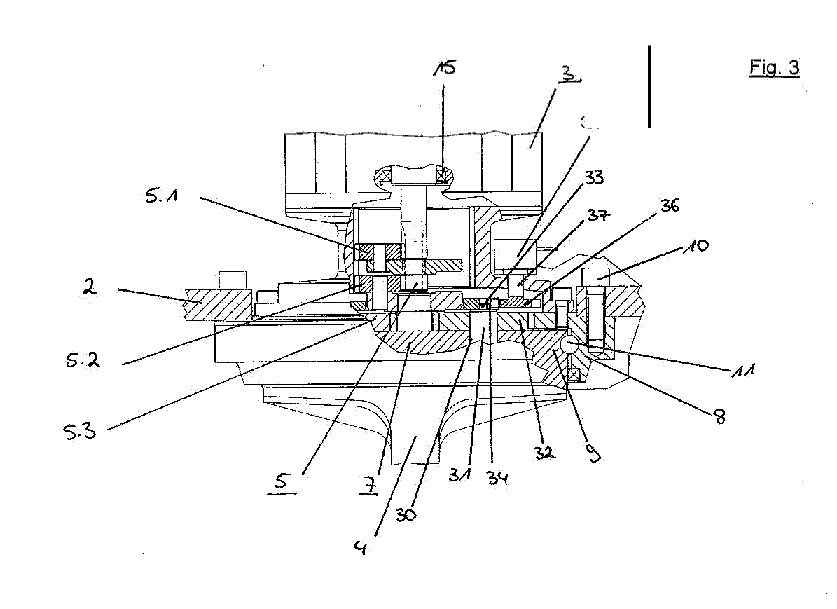

FIG. 3 shows the planetary reduction gear system 5 in a cut partial view with the planetary reduction gears 5.1, 5.2 and 5.3, and the steering motor 3 disposed above. The rotating bearing assembly inner race 9 of the rotating bearing assembly 7 simultaneously forms the output stage planet carrier. The rotating bearing assembly outer race 8 is connected to the housing 2 by threaded bolts 10. The planet carrier or the rotating bearing assembly inner race 9 has bores 30, in which the planetary gear axles 31 for the planets 32 of the last planet reduction gear 5.3 are supported.

A gear disc 34 is disposed on a planetary gear axle 31, resting on a shoulder 33 and drives a sprocket gear 36, which in turn controls a rotation angle sensor 35. The rotation angel sensor 35 is provided with an encoding means for sending date related to the rotation angle.

Control of the rotation angle sensor 35 can be performed directly through the gear disc 34, or alternatively, as in the embodiment depicted, the rotation angle sensor 35 can be controlled via an additional sprocket gear 36. The gear disc 34 rotates with the planet carrier 6, so that through the gear disc 34 and the sprocket gear 36 the respective position of the steering angle of the running wheels 109 can be detected. For this purpose the rotation angle sensor 35 is provided with sensor elements, these can, for example, be magneto sensitive elements, which are controlled through encoding, e.g. a modulated gearing, and can thus detect the absolute value of the rotation angle. Alternatively, a perforated disc with light switches or reflection light switches may be used. The rotation angle sensor 35 is connected to the side of the housing 2 through a flange and protrudes through a bore hole 37 into the housing 2, so that a coupling can be performed with the sprocket gear 36.

The invention has been described in regard to its preferred embodiment. It will be apparent to those skilled in the art that the same may be varied in many ways without departing from the spirit and scope of the invention. All such modifications are intended to be included within the scope of the following claims.

What is claimed is:

1. A steering apparatus for a vehicle comprising:
a steering motor comprising a rotating drive shaft;
a reduction gear stage;
a rotating bearing assembly, and;
a rotatable running wheel carrier,
said rotating drive shaft in operable connection with said reduction gear stage and said reduction gear stage in operable connection with said rotating bearing assembly, said reduction gear stage further comprising:
a housing, and;
means for transmitting the rotational force of said drive shaft to said rotating bearing assembly and for reducing the rotational speed of the rotational force transmitted;
said rotating bearing assembly comprising an inner race and an outer race, said inner race in torque-proof connection with said rotatable running wheel carrier, said outer race in torque-proof connection with said housing, wherein the rotational force of said drive shaft is transmitted through said reduction gear stage to said rotating bearing assembly so that said inner race and said rotatable running wheel carrier rotate in relation to said outer race and at a rotational speed slower than the rotational speed of said rotating drive shaft.

2. The steering apparatus of claim 1 wherein said steering motor, said reduction gear stage, and said rotating bearing assembly are arranged symmetrically around the axis central to said drive shaft.

3. The steering apparatus of claim 1 wherein said means for transmitting the rotational force of said drive shaft to said rotating bearing assembly and for reducing the rotational speed of the rotational force transmitted comprises at least one planetary gear.

4. The steering apparatus of claim 3 wherein said inner race comprises a planet carrier for at least one planetary gear.

5. The steering apparatus of claim 1 wherein said means for transmitting the rotational force of said drive shaft to said rotating bearing assembly and for reducing the rotational speed of the rotational force transmitted comprises a plurality of planetary gears arranged in a plurality of stages.

6. The steering apparatus of claim 5 wherein said inner race comprises a planet carrier for at least one planetary gear.

7. The steering apparatus of claim 1 wherein said rotatable wheel carrier is integral to said inner race.

8. The steering apparatus of claim 1 wherein a seal is disposed between said inner race and said outer race.

9. The steering apparatus of claim 1 wherein said steering motor comprises an electric motor.

10. The steering apparatus of claim 1 further comprising a gear disc and a rotation angle sensor, said gear disc operably connected to said inner race wherein said gear disc rotates in relation to rotation of said inner race, said gear disc further operably connected to said rotation angle sensor wherein rotation of said gear disc is detectable by said rotation angle sensor.

11. The steering apparatus of claim 4 or claim 6 further comprising a gear disc and a rotation angle sensor, said gear disc disposed on the axis of at least one planetary gear and operably connected to said inner race wherein said gear disc rotates in relation to rotation of said inner race, said gear disc further operably connected to said rotation angle sensor wherein rotation of said gear disc is detectable by said rotation angle sensor.

12. A steering apparatus for a vehicle comprising
a steering motor, said steering motor comprising a rotating drive shaft;
a rotatable wheel carrier, and;
means for transmitting the rotational force from said drive shaft to rotate said rotatable wheel carrier at a rotational speed slower than the speed of said rotating drive shaft.

13. The steering apparatus of claim 12 wherein said steering motor comprises an electric motor.

14. The steering apparatus of claim 12 further comprising means for detecting the relative rotation of said rotatable wheel carrier.

15. The steering apparatus of claim 14 wherein said means for detecting the relative rotation of said rotatable wheel carrier comprises a rotation angle sensor operably connected to said rotatable wheel carrier.

16. The steering apparatus of claim 12 where said means for transmitting the rotational force from said drive shaft to rotate said rotatable wheel carrier at a rotational speed slower than the speed of said rotating drive shaft comprises at least one planetary gear and at least one planet carrier.

17. The steering apparatus of claim 16 wherein said means for detecting the relative rotation of said rotatable wheel carrier comprises a rotation angle sensor operably connected to at least one planetary gear.

18. The steering apparatus of claim 12 where said means for transmitting the rotational force from said drive shaft to rotate said rotatable wheel carrier at a rotational speed slower than the speed of said rotating drive shaft comprises a plurality of planetary gears and a plurality of planet carriers.

19. The steering apparatus of claim 18 wherein said means for detecting the relative rotation of said rotatable wheel carrier comprises a rotation angle sensor disposed on the axis of at least one planetary gear.

20. The steering apparatus of claim 18 wherein said plurality of planetary gears and plurality of planet carriers are disposed in a plurality of stages.

21. The steering apparatus of claim 21 wherein said means for detecting the relative rotation of said rotatable wheel carrier comprises a rotation angle sensor disposed on the axis of at least one planetary gear.
